(19) United States
(12) Patent Application Publication
(10) Pub. No.: US 2013/0001837 A1
(43) Pub. Date: Jan. 3, 2013

(54) TURBINE BLADE AND METHOD FOR ITS PRODUCTION

(76) Inventors: Jens Göhler, Stauchitz (DE); Frank Kernstock, Nurnberg (DE); Olaf Rehme, Hamburg (DE); Martin Schäfer, Berlin (DE)

(21) Appl. No.: 13/498,415

(22) PCT Filed: Sep. 14, 2010
(86) PCT No.: PCT/EP2010/063443

§ 371 Date: Sep. 12, 2012

(30) Foreign Application Priority Data
Sep. 28, 2009 (DE) 102009048665.8

(51) Int. Cl. B29C 35/08

(52) U.S. Cl. 264/497

(57) ABSTRACT

A method of producing a turbine blade is provided, wherein the turbine blade is produced by an additive production method. Cavities and/or lattice structures can be produced in one and the same process. The additive production method also allows drainage slots, heating openings, and/or other holes or, as the case may be, recesses to be provided in the turbine blade while the turbine blade is being produced. Holes can furthermore be furnished completely or partially with a lattice structure.

### CROSS REFERENCE TO RELATED APPLICATIONS

This application is the US National Stage of International Application No. PCT/EP2010/063443 filed Sep. 14, 2010, and claims the benefit thereof. The International Application claims the benefits of German Application No. 10 2009 048 665.8 DE filed Sep. 28, 2009. All of the applications are incorporated by reference herein in their entirety.

### FIELD OF INVENTION

The invention relates inter alia to a method for producing a turbine blade.

### BACKGROUND OF INVENTION

A method of such kind is known from, for example, German patent DE 10 2006 030 365 B3. According to said already known method a turbine blade is produced using a metal-casting process.

### SUMMARY OF INVENTION

An object of the invention is to disclose a method for producing a turbine blade that will enable particularly light but nonetheless stable turbine blades to be produced.

Said object is achieved by a method having the features as claimed in the independent claim. Advantageous embodiments of the method are described in the dependent claims.

According thereto it is inventively provided for the turbine blade to be produced by means of an additive production method.

A major advantage of the inventive method is that it allows very many degrees of freedom in designing the turbine blade. For example in contrast to the metal-casting process described in the introduction it is possible with the inventive method to very simply produce a turbine blade that has cavities and/or lattice structures or suchlike. Blade designs of such complexity cannot—at least cannot readily—be realized using a metal-casting process.

Another major advantage of the inventive method can be seen in its allowing all features of the turbine blade, at least all major features of the turbine blade, to be produced by means of one and the same method, in other words at the same time. For example the additive production method will allow drainage slots, heating openings, and/or other holes or, as the case may be, recesses to be provided in the turbine blade even while it is being produced without the need for additional tools or any further, ensuing steps of the method.

Additive production methods are already known per se from other technical fields. By way of example only, reference is made in this connection to the publication titled “Wohlers Report 2008” (Terry T. Wohlers, Wohlers Associates Inc., Fort Collins, Colo., USA, ISBN 0-9754429-4-5). That publication contains examples of how additive production methods can be specifically implemented.

The turbine blade can be produced particularly simply and hence advantageously in layers. Preferably a first powder layer is melted locally by means of an energy beam with a first blade layer being formed; further powder layers each melted locally with further blade layers being formed are then applied layer by layer thereupon, which is to say on said first blade layer. The turbine blade will in that way be formed by a multiplicity of single layers applied one upon the other.

As an alternative to powder layers it is possible also to use liquid layers that are solidified locally by means of an energy beam so that the turbine blade will be assembled from layers in that manner.

The turbine blade is particularly preferably produced in a metallic powder bed by means of a laser beam or electron beam. The laser or electron beam serves therein to selectively melt on the thin powder layers which after cooling will form the turbine blade.

Preferably CAD data describing the three-dimensional turbine blade by means of a volume model or surface model is processed for driving the energy beam. For processing, the CAD data is converted preferably into layer data prior to or during the additive production process, with each layer corresponding to a cross-section of the turbine blade having a finite layer thickness.

The turbine blade's cross-sectional geometry is produced during the additive production method preferably by linearly exposing the external contours and area-exposing the cross-sections requiring to be filled. Linear exposing is realized preferably by moving the beam accordingly when the energy beam has a punctiform characteristic. Areal exposing can be realized by, for example, joining linear exposing operations together.

Turbines, for example steam or gas turbines, can have a multiplicity of different types of turbine blades. Alongside rotating rotor blades, in many cases turbines also include non-rotating or, as the case may be, static guide blades that are shaped similarly to the rotor blades and can have the form of, for example, a supporting surface. Guide blades serve primarily to selectively direct the flow of the flow medium inside the turbine. Turbines can furthermore include compressor blades for a compressor section of the turbine. It is for that reason regarded as advantageous for a rotor blade, a guide blade, or a compressor blade for a compressor section of the turbine to be produced as the turbine blade within the scope of the additive production method.

To reduce the weight of the turbine blade it is regarded as advantageous for at least one cavity to be formed between blade walls of the turbine blade. In order nonetheless to ensure a high degree of stability for the turbine blade, a cavity of such kind is preferably filled at least in sections with a lattice structure. A lattice structure of such kind is preferably three-dimensional and can include, for example, filigree, open-cell 3D space lattice structures.

It is regarded as especially advantageous for the blade walls separated by a cavity to be mutually linked at least in sections by lattice structures in order to achieve supporting of the blade walls one against the other by means of the lattice structures. For example the turbine blade's suction-side blade wall and the turbine blade's pressure-side blade wall are mutually linked at least in sections by a corresponding lattice structure to increase the turbine blade's overall stability.

The described supporting of the blade walls by means of lattice structures will moreover allow thinner blade walls to be produced, meaning ones having less profile-wall thickness, than would be the case with hollow turbine blades.

It is moreover regarded as advantageous for at least one drainage slot to be produced in the turbine blade within the scope of the additive production method. Drainage slots of such kind are used preferably for ducting water that has condensed out of the current of steam flowing through the turbine away from the flow medium's flow close to the wall. The drops forming on the wall as condensation can cause erosion damage to the turbine's rotor blades in turbine stages that follow. Erosion damage of such kind can, though, be reduced if—as proposed—drainage slots are provided by means of which the water drops can be reduced in size. The water drops will as a result experience a faster speed and hence one that is slower relative to the rotor blades' rotational motion, as a consequence of which the erosion damage due to the water drops will be reduced.

The drainage slots are particularly preferably located close to the turbine blade's back edge. The drainage slots are situated for example in the third of the pressure-side blade wall nearest the back edge. On the suction-side blade wall the drainage slots are situated for example in the front third after the inlet edge.

Locating drainage slots particularly close to the back edge will be possible if a lattice structure is provided inside the turbine blade because a particularly thin blade-wall thickness can be employed in such a case.

It is alternatively and/or additionally also possible to realize further features of the turbine blade during the additive production method: Thus, for example, heating openings for reducing the water drops in the turbine and/or other holes in the blade wall can be produced. The heat transfer between the heating or cooling medium inside the blade will furthermore be favored by the lattice structure and its large surface.

So that the turbine blade's stability is not adversely affected by drainage slots or heating openings, for example through their forming predetermined breaking points, it is regarded as advantageous for drainage slots, heating openings, other holes, or other openings to be furnished at least partially with lattice structures that will provide support.

The invention relates furthermore to a turbine blade. It is inventively provided in this regard for there to be a cavity, filled at least in sections with a lattice structure, between blade walls of the turbine blade.

A major advantage of the inventive turbine blade can be seen in its having a high degree of stability accompanied by a low weight.

The turbine blade is preferably a guide blade, a rotor blade, or a compressor blade.

To ensure a particularly high degree of stability for the turbine blade, the turbine blade's suction-side blade wall and the turbine blade's pressure-side blade wall are mutually linked by a lattice structure. Linking of such kind will make it possible to achieve supporting of the blade walls one against the other and hence to ensure a particularly high degree of stability.

Any openings or holes in the blade walls will preferably have been furnished—at least partially—with a lattice structure.

The invention relates furthermore to a turbine, in particular a gas turbine or steam turbine, fitted with at least one turbine blade as described above. The turbine blade preferably forms inside the turbine a static guide blade, a rotating rotor blade, or a compression blade.

### BRIEF DESCRIPTION OF THE DRAWINGS

The invention is explained in more detail below with the aid of exemplary embodiments whose contents are shown by way of example:

FIG. 1 is an oblique side view of an exemplary embodiment of an inventive turbine blade in a three-dimensional representation,

FIG. 2 is a cross-sectional view of the turbine blade shown in FIG. 1,

FIG. 3 is a top view of the pressure-side blade wall of the turbine blade shown in FIG. 1,

FIG. 4 is a top view of the suction-side blade wall of the turbine blade shown in FIG. 1,

FIG. 5 is a cross-sectional view by way of example of a hole in a blade wall of the turbine blade shown in FIG. 1, with the hole having been completely filled with a lattice structure,

FIG. 6 is a cross-sectional view by way of example of a hole in a blade wall of the turbine blade shown in FIG. 1, with the hole having been partially filled with a lattice structure, and

FIG. 7 is a cross-sectional view by way of example of a hole in a blade wall of the turbine blade shown in FIG. 1, with the hole being supported from below by a lattice structure.

### DETAILED DESCRIPTION OF INVENTION

For clarity's sake the same reference numerals/letters are always used in the figures for components that are identical or comparable.

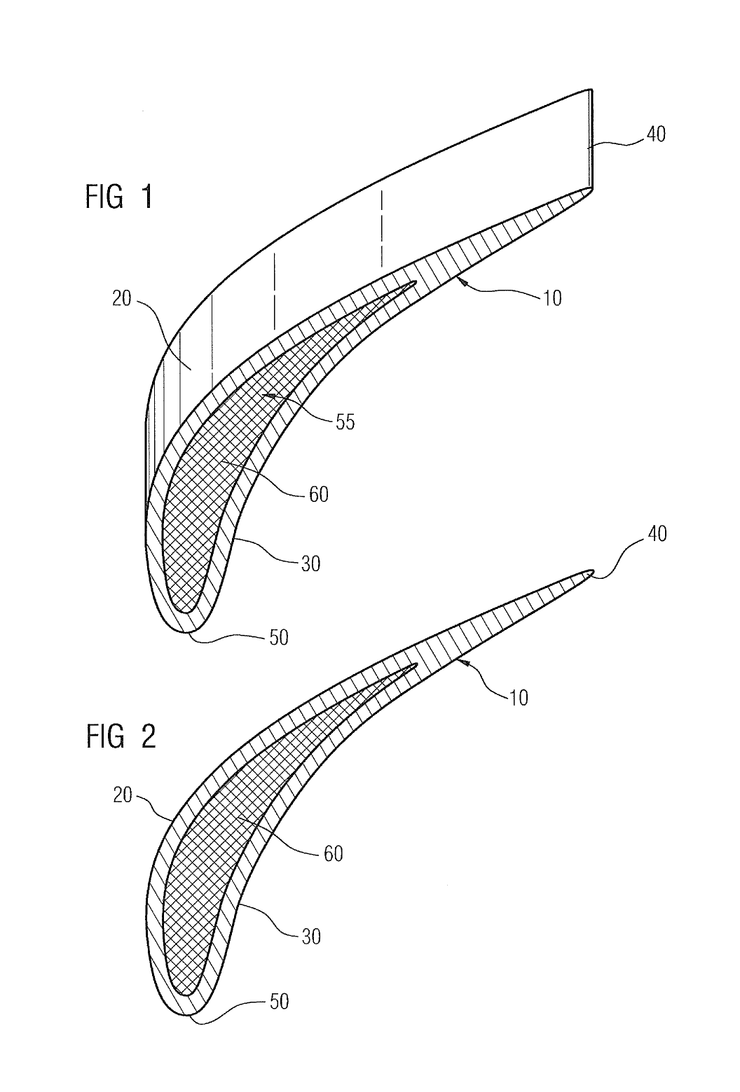

To be seen in FIG. 1 is a turbine blade 10 that includes a suction-side blade wall 20 and a pressure-side blade wall 30. Suction-side blade wall 20 and pressure-side blade wall 30 are mutually linked at a back edge 40 and at a front edge 50.

Further to be seen in FIG. 1 is that cavity 55 between the two blade walls 20 and 30 is furnished with a three-dimensional lattice structure identified by reference numeral 60.

Turbine blade 10 shown in FIG. 1 is produced within the scope of an additive production method during which suction-side blade wall 20, pressure-side blade wall 30, and lattice structure 60 are produced simultaneously from the same material.

FIG. 2 is a cross-sectional representation of turbine blade 10 shown in FIG. 1. To be seen are blade walls 20 and 30, back edge 40, front edge 50, and lattice structure 60.

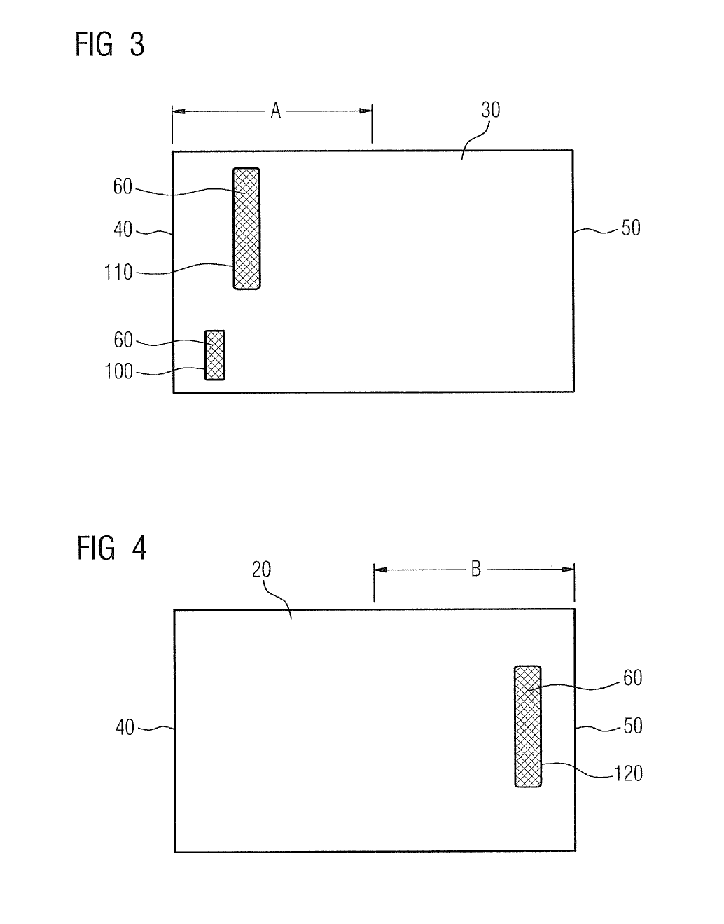

FIG. 3 is a top view, in greater detail, of pressure-side blade wall 30 of turbine blade 10 shown in FIGS. 1 and 2. It can be seen that blade wall 30 has two slot-shaped holes 100 and 110. The slot-shaped holes can serve as drainage slots and/or heating openings by means of which water is ducted away from the flow, close to the wall, of the flow medium flowing through the turbine.

As can readily be seen from FIG. 3 the arrangement of slot-shaped holes 100 and 110 has been selected such that they are situated as close as possible to back edge 40, so as far as possible from front edge 50. Slot-shaped holes 100 and 110 are arranged particularly preferably in half A of pressure-side blade wall 30 located against back edge 40.

FIG. 4 shows by way of example suction-side blade wall 20 of turbine blade 10. It can be seen that arranged in the region of front edge 50 is a slot-shaped hole 120 that extends through blade wall 20. Slot-shaped hole 120 is arranged particularly preferably in half B of suction-side blade wall 20 located against front edge 50. Lattice structure 60 arranged inside turbine blade 10 can be located outside slot-shaped hole 120 or can alternatively extend into slot-shaped hole 120.

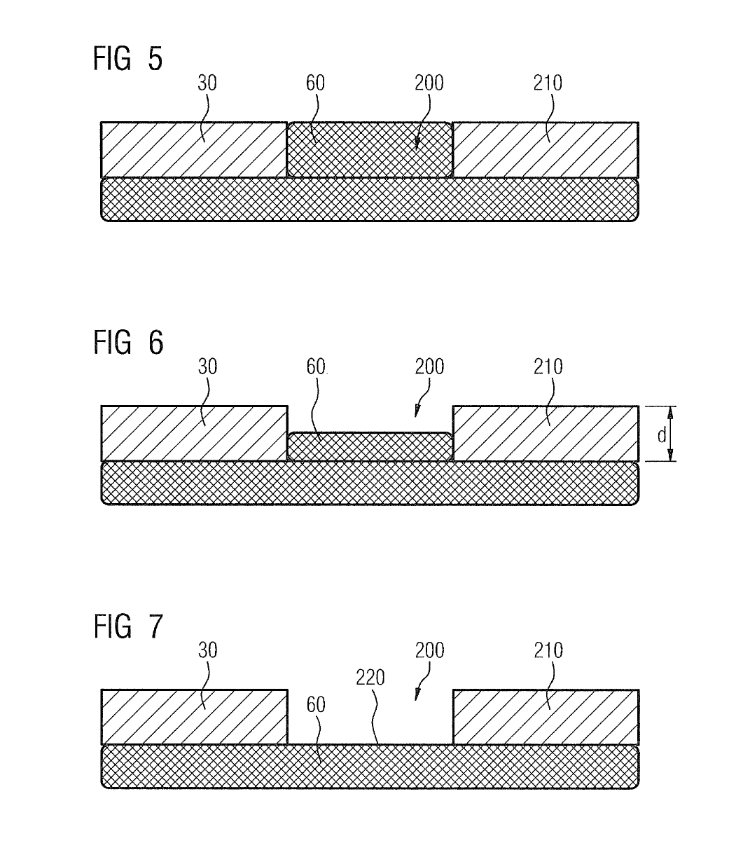

Shown in FIG. 5 is an exemplary embodiment in which lattice structure 60 extends completely into a hole 200 of blade wall 210 of turbine blade 10. Hole 200 is hence bridged by lattice structure 60 and supported by it.

Shown by way of example in FIG. 6 is an embodiment in which lattice structure 60 extends only partially into hole 200. About half the wall thickness d of lattice structure 60 is covered in the exemplary embodiment shown in FIG. 6; the other half of the wall thickness remains free of lattice structure 60.

Shown in FIG. 7 is an exemplary embodiment of a hole 200 that is not furnished at all with a lattice structure 60. Lattice structure 60 extends only up to bottom edge 220 of hole 200 or, as the case may be, borders hole 200 without actually projecting into the hole. Lattice structure 60 is thus only located inside the turbine blade and not in the region of hole 200.

1.-13. (canceled)

14. A method for producing a turbine blade,
wherein the turbine blade is produced by an additive production method, and
wherein at least one hole in form a drainage slot or heating opening is produced in at least one blade wall in the turbine blade by the additive production method.

15. The method as claimed in claim 14, wherein the turbine blade is produced in layers
by melting a first powder layer locally by an energy beam with a first blade layer being formed, and
by applying further powder layers thereupon layer by layer and melting each of them locally, then cooling them with further blade layers being formed.

16. The method as claimed in claim 14, wherein the turbine blade is produced by selective laser melting.

17. The method as claimed in claim 14, wherein a rotor blade, a static guide blade, or a compressor blade for a compressor section of a turbine is produced as the turbine blade.

18. The method as claimed in claim 14, wherein a cavity, that is filled at least in sections with a lattice structure, is formed between a pressure-side blade wall and a suction-side blade wall.

19. The method as claimed in claim 18, wherein the lattice structure is topologically optimized and includes a locally different structure and/or locally different bar diameter.

20. The method as claimed in claim 18, wherein the suction-side blade wall and pressure-side blade wall are mutually linked by the lattice structure.

21. The method as claimed in claim 19, wherein the suction-side blade wall and pressure-side blade wall are mutually linked by the lattice structure.

22. The method as claimed in claim 20, wherein the hole is furnished at least partially with a lattice structure.

23. The method as claimed in claim 21, wherein the hole is furnished at least partially with a lattice structure.
